(19) United States
(12) Patent Application Publication
(10) Pub. No.: US 2004/0069945 A1
(43) Pub. Date: Apr. 15, 2004

(54) Method for measuring an electrical charge of a photoresist layer

(75) Inventors: Shyue Sheng, Hsin-Chu (TW); Chih-Ming Ke, Hsin-Chu (TW); Hua Tai, Yu-Kuang City (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/267,525

(22) Filed: Oct. 9, 2002

(51) Int. Cl. G01N 23/225

(52) U.S. Cl. 250/307; 250/310

(57) ABSTRACT

A method for determining a surface charge state of a semiconductor wafer process surface including providing a semiconductor wafer having a process surface including patterned semiconductor features; positioning the semiconductor wafer in a scanning electron microscope (SEM) for imaging at least a portion of the process surface; adjusting an electron beam condition to produce an image of the at least a portion of the process surface including an electron beam Voltage; and, determining a Voltage present in the at least a portion of the process surface to determine a surface charge state of the process surface.

### FIELD OF THE INVENTION

This invention generally relates to metrology and more particularly to a method for measuring electrical charge in photoresist layers in semiconductor manufacturing processes.

### BACKGROUND OF THE INVENTION

Since the introduction of semiconductor devices, the size of semiconductor devices has been continuously shrinking, resulting in smaller semiconductor chip size and increased device density. One of the limiting factors in the continuing evolution toward smaller device size and higher density has been the stringent requirements placed on photolithographic processes as line width and step heights have decreased for device features. As one way to overcome such limitations, various methods have been implemented to increase the resolution performance of photoresists and to increase critical dimension uniformity (CDU) in the photolithographic patterning process.

Typically a photoresist layer is applied to a semiconductor wafer surface, for example, by spin coating a resinous layer over the process surface. The photoresist layer is then aligned and exposed to activating light, for example ultraviolet light (e.g., less than about 400 nm wavelength) through a photomask to transfer the mask image to the photoresist layer. The photoresist then typically undergoes a post exposure baking (PEB) process at to improve adhesion and structural stability and smooth out standing wave profiles in I-line photoresists and to initiate catalyzed photoresist reactions in chemically amplified photoresists.

Following the PEB, a development process is carried out, the development process being the most critical step in accurately reproducing the mask image in the photoresist layer. The soluble portions of the photoresist are dissolved by liquid development chemicals. Since the goal is to accurately control CD features (minimum geometry features) to meet specifications,

the development process must be properly controlled to avoid achieve acceptable photoresist profiles.

Several metrology tools are used in evaluating photoresist processes. For example, the surface charge of a photoresist is frequently desirable to measure. For example, excessive absorption of incident radiation by the photoresist in the exposure process may cause degradation of the feature profile during the development process. Measuring the surface charge of photoresist layer can provide information concerning the degree of light absorption by the photoresist.

In addition, surface charge measurements of photoresist provide information concerning contamination of photoresist thereby allowing improvement of in-line photoresist patterning processes. Yet other metrology processes measure the surface charge of a photoresist layer prior to and following plasma etching processes, such as an ashing process, to determine damage caused by the plasma processes to underlying material layers, for example semiconducting materials, oxides or dielectrics.

The surface charge of a photoresist is also useful as a metrology tool where charged particle beams are used to selectively expose the photoresist layer. For example, ion beam lithography and e-beam lithography apply a beam of charged particles to the photoresist layer to form an exposure pattern. Since photoresists are generally non-conductive charged particles penetrate and are deposited in the photoresist layer. The charged particles generate and electrical filed which can undesirably deflect subsequently penetrating charged particles as a charge particle beam attempts to expose an adjacent area in the photoresist layer. As a result, excessive charging of the resist layer causes displacement of the pattern causing a loss of critical dimension and overlay accuracy.

Another are where the measurement of photoresist charge is advantageous is where ion implantation is carried out on the photoresist layer prior to scanning electron microscopic (SEM) examination to render the photoresist layer sufficiently conductive to resist surface charging during SEM examination. For example surface charging during SEM examination distorts the image making the examination of developed patterns in the photoresist layer impractical. Determining a surface charge state of the photoresist layer following ion implantation is a useful metrology tool to assure a proper surface charge state for SEM examination. This ion-implantation technique is outlined in commonly assigned U.S. Pat. No. 5,783,366 which is herein incorporated by reference.

Prior art methods of measuring charged wafer surfaces including photoresist layers have employed both contact and non-contact methods to determine surface charges. A non-contact method, such as a corona-oxide-semiconductor (COS) technique is has been used for surface charge measurements of photoresist layers. In the COS technique the photoresist is biased by charging the photoresist surface. The bias in charge per unit surface area is measured by a coulomb meter. In one method, a response of the photoresist is measured by a surface voltage response following charging. For example the surface voltage is measure by a Kelvin probed.

One problem with prior art methods for measuring a wafer surface electrical charge state including a photoresist layer electrical charge is the limited ability to measure high surface Voltage. For example many commercially available apparatus for measuring surface voltage using non-contacting methods are limited in the amount of surface charging and the ability to measure higher surface charges. For example, measurements of surface voltages are limited to about 100 Volts.

There is therefore a need in the semiconductor processing art to develop a method whereby a wafer surface charge, including a photoresist layer, may be determined over a broader range of values.

It is therefore an object of the invention to provide a method whereby a method whereby a wafer surface charge, including a photoresist layer, may be determined over a broader range of values while overcoming other shortcomings and deficiencies of the prior art.

### SUMMARY OF THE INVENTION

To achieve the foregoing and other objects, and in accordance with the purposes of the present invention, as embodied and broadly described herein, the present invention provides a method for determining a surface charge state of a semiconductor wafer process surface.

In a first embodiment, the method includes providing a semiconductor wafer having a process surface including patterned semiconductor features; positioning the semiconductor wafer in a scanning electron microscope (SEM) for imaging at least a portion of the process surface; adjusting an electron beam condition to produce an image of the at least a portion of the process surface including an electron beam Voltage; and, determining a Voltage present in the at least a portion of the process surface to determine a surface charge state of the process surface.

These and other embodiments, aspects and features of the invention will be better understood from a detailed description of the preferred embodiments of the invention which are further described below in conjunction with the accompanying Figures.

### BRIEF DESCRIPTION OF THE DRAWINGS

FIG. 1 is a schematic cross sectional representation of elements of a scanning electron microscope for using the method of the present invention.

FIG. 2 is a process flow diagram representing several embodiments of the present invention.

### DETAILED DESCRIPTION OF THE PREFERRED EMBODIMENTS

Although the method of the present invention is explained with reference to a surface charge measurement of a photoresist layer it will be appreciated that the surface charge measuring technique of the present invention may be applied to the measurement of a material layer in an integrated circuit manufacturing process where a non-contacting technique is advantageously used to measure a surface charge.

In a first embodiment, a semiconductor wafer having a process surface is provided in a scanning electron microscope disposed on a wafer holding stage the semiconductor wafer being in communication with one of an electrical ground or electrical bias. The electron beam is aligned and adjusted for imaging a measurement area portion of the process surface. A measurement area portion of the process surface area then brought into focus. A Voltage present in the measurement area portion of the process surface is then determined by subtracting a landing voltage from the electron beam Voltage to determine a process wafer surface Voltage.

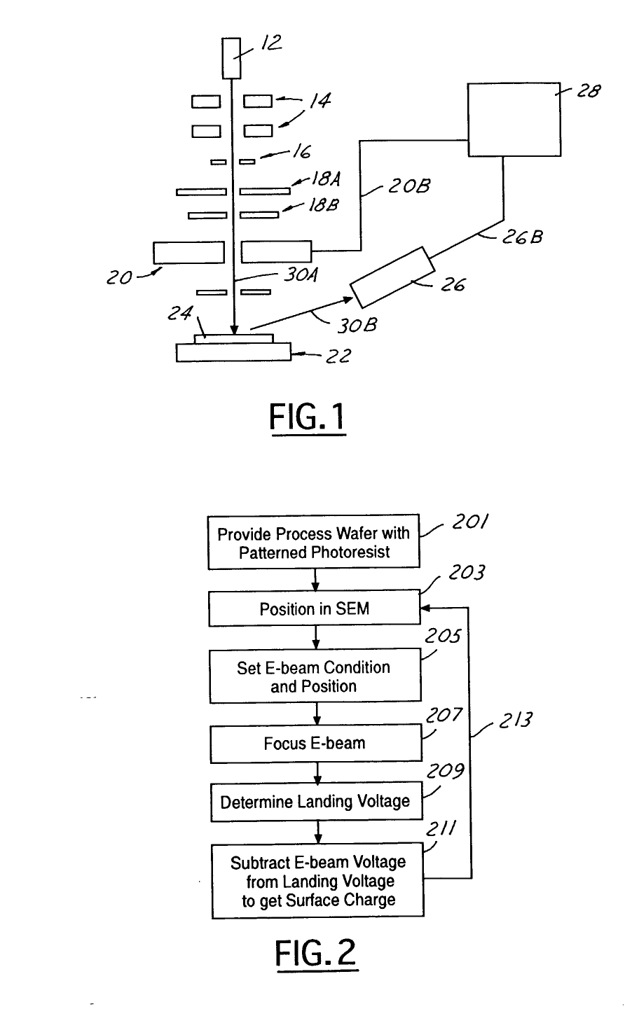

For example, referring to FIG. 1 is a schematic cross sectional representation of elements of a scanning electron microscope (SEM), for example, used in determining critical dimensions in a photoresist layer following photoresist patterning (exposure and development). For example, the SEM includes a filament 12 for emitting electrons which includes an electron extractor e.g., 14 where the electron beam is shaped while being accelerated through anode 16. A condenser lenses, e.g., 18A and 18B further shape the beam profile prior to passing through magnets 20 for moving the beam in an X and Y direction to scan the electron beam over the imaged surface. X-Y stage 22 is either electrically grounded or biased and supports an imaging specimen, for example a process wafer 24. An electron detector 26 is positioned to one side of the process wafer to captures electron beam electrons back scattered from the process wafer surface after impact as indicated by electron directional arrows 30A and 30B, respectively. The detector is in electrical communication e.g., electrical communication line 26B with a display system, for example, including a CRT 28 which displays an image of a portion of the process wafer 24 with the aid of information supplied from the scanning magnets 20 supplied by electrical communication line 20B. For example, the X-Y stage 22 can tilt to vary the orientation of the process wafer 24. The X-Y stage 22 and the electron beam including beam forming components are housed in a high vacuum environment, for example operating at about 10⁻⁶ Torr. As will be recognized by one skilled in the art of scanning electron microscopy, there are a wide variety of additional metrology tools that may be added to the imaging functions of the SEM including X-ray compositional analysis and focused ion beam milling.

For example in an exemplary embodiment, a process wafer comprising a patterned and developed photoresist layer formed over a dielectric layer is provided prior to carrying out a reactive ion etching (RIE) process to anisotropically etched features according to the patterned photoresist layer. The process wafer is loaded into the SEM being supported on the X-Y stage, for example, in an electrically grounded state. Conventional processes for bringing the electron gun up to an operating filament current, and adjusting the electron beam characteristics by adjusting a beam accelerating voltage as well as focusing the electron beam by adjusting the lens (condenser) current and lens voltage are carried out to prepare the SEM for a conventional imaging process. For example in one embodiment, the beam voltage is adjusted from about 1 KeV to about 20 keV. It will be appreciated that the various operating parameters, for example lens voltage and current, filament current, and beam current will vary depending on numerous parameters including the sample material, sample position, vacuum conditions, the sample material, as well as the age of the filament and the cleanliness of the beam forming parts.

In an exemplary embodiment, the beam voltage is adjusted from about 3 KeV to about 6 KeV and the electron beam and the X-Y stage adjusted for imaging a selected area of the process wafer. The electron beam is then adjusted to achieve a focused image of the process wafer surface with appropriate contrast and a voltage induced in the process wafer by the electron beam is determined, also referred to as a landing voltage. The landing voltage is subtracted from the electron beam Voltage to determine a surface voltage (charge) of the process wafer surface (i.e., surface charge present prior to imaging with electron beam) to thereby give a surface charge of the selected area of the process wafer surface. The landing Voltage includes the voltage induced in the process surface by the electron beam. The higher the surface voltage present in the process surface prior to imaging with the electron beam, the lower will be the landing voltage. The process wafer is then moved to re-position the electron beam over another process surface portion and another surface voltage is determined for another imaged wafer process surface portion. The process is preferably repeated over several selected areas to produce a graphical representation of the surface charge state of the process wafer surface, preferably photoresist layer, at selected areas over the process surface.

Preferably the SEM used in the method of the present invention is supplied with automated controls for adjusting the various beam parameters. More preferably, the SEM is provided with a computer controlled graphical user interface including displays of the various beam parameters including electron beam voltage. Preferably, the SEM is equipped with a processing system for retrieving and storing electron beam condition parameters including a beam Voltage and a landing Voltage.

For example, according to the present invention it has been found that the surface Voltage of a photoresist layer can be measured up to a value of about 400 Volts in contrast to prior art non-contacting methods where surface Voltages were limited to about 100 Volts. For example, suitable commercially available SEM'S also known as CD-SEM'S are commercially available from KLA-Tencor Corporation and Hitachi Corporation.

Referring to FIG. 2 is a process flow diagram including several embodiments of the present invention. In process 201 a semiconductor process wafer having a process surface including a patterned photoresist layer is provided. In process 203, the wafer is positioned in a scanning electron microscope (SEM) for optionally determining critical dimensions of the patterned photoresist layer and for determining a surface charge of the photoresist layer. In process 205, the electron beam and process wafer are positioned to produce an image of at least a portion of the wafer process surface. In process 207, the electron beam is focused to produce a focused image of the process surface. In process 209, a landing Voltage is determined. In process 211 a surface charge state of the photoresist layer imaged portion is determined by subtracting the landing Voltage from the electron beam Voltage. As indicated by process directional arrow 213, the processes 203-211 are repeated to determine a surface charge at selected portions of the process surface.

A particular advantage of the present invention is that the critical dimension (CD) inspection of semiconductor feature may be carried out in an SEM examination process in parallel with a surface charge state determination. The method is particularly advantageous for measuring surface voltages greater than about 100 Volts where a non-contacting surface charge measurement method is required, for example when measuring the surface charge of photoresist layers. The method of the present invention obviates the necessity of carrying out a separate or ex-situ surface charge measurement of a patterned photoresist layer prior to carrying out an SEM CD determination process. Thus, the method of the present invention provides for an in-situ surface charge state determination for a patterned photoresist layer during an SEM CD determination process. By 'CD determination process' is meant the SEM process of measuring feature dimensions in an SEM apparatus the feature dimensions also referred to as critical dimensions.

The preferred embodiments, aspects, and features of the invention having been described, it will be apparent to those skilled in the art that numerous variations, modifications, and substitutions may be made without departing from the spirit of the invention as disclosed and further claimed below.

What is claimed is:

1. A method for determining a surface charge state of a semiconductor wafer process surface comprising the steps of:
providing a semiconductor wafer having a process surface including patterned semiconductor features;
positioning the semiconductor wafer in a scanning electron microscope (SEM) for imaging at least a portion of the process surface;
adjusting an electron beam condition to produce an image of the at least a portion of the process surface including an electron beam Voltage; and,
determining a Voltage present in the at least a portion of the process surface to determine a surface charge state of the process surface.

2. The method of claim 1 wherein the process surface comprises an exposed photoresist layer without an overlying conductive layer.

3. The method of 1, wherein the step of determining a Voltage is performed in-situ with respect to a process for performing dimensional measurements of the patterned semiconductor features.

4. The method of claim 1, wherein the step of adjusting an electron beam condition includes adjusting and electron beam Voltage in the range of about 1 keV to about 20 keV.

5. The method of claim 4, wherein the step of adjusting an electron beam condition includes adjusting and electron beam Voltage in the range of about 3 keV to about 10 keV.

6. The method of claim 1, wherein the step of determining a Voltage includes subtracting a landing Voltage from the electron beam Voltage.

7. The method of claim 6, wherein the semiconductor wafer is one of electrically biased and electrically grounded.

8. The method of claim 1, wherein the step of adjusting an electron beam condition comprises producing a focused image of the at least a portion of the process surface.

9. The method of claim 2, wherein the Voltage present in the at least a portion of the process surface is greater than an absolute value of between about 100 Volts.

10. The method of claim 1, wherein the steps of positioning, adjusting and determining are repeated over selected areas of the process surface.

11. A method for determining a surface charge of a semiconductor wafer process surface comprising an exposed photoresist layer comprising the steps of:
providing a semiconductor wafer having a process surface including a patterned photoresist layer;
positioning the semiconductor wafer in a scanning electron microscope (SEM) for imaging at least a portion of the process surface to include measuring dimensions of the patterned photoresist layer;
adjusting an electron beam condition including an electron beam Voltage to produce a focused image of at least a portion of the process surface; and,
determining a surface charge state of the at least a portion of the process surface by subtracting a landing Voltage from the electron beam Voltage.

12. The method of claim 11 wherein the process surface comprises an exposed photoresist layer without an overlying conductive layer.

13. The method of 12, wherein the step of determining a surface charge state is performed in-situ with respect to a parallel process for performing dimensional measurements of the patterned photoresist layer.

14. The method of claim 13, wherein the step of adjusting an electron beam condition includes adjusting and electron beam Voltage in the range of about 1 keV to about 20 keV.

15. The method of claim 14, wherein the landing Voltage includes a Voltage induced in the process surface by the electron beam.

16. The method of claim 15, wherein the semiconductor wafer is one of electrically biased and electrically grounded.

17. The method of claim 16, wherein the step of adjusting an electron beam condition comprises producing a focused image of the process surface.

18. The method of claim 17, wherein the surface charge state comprises a Voltage between an absolute value of about 100 Volts and about 400 Volts.

19. The method of claim 11, wherein the step of determining a surface charge state replaces an ex-situ non-contacting method of determining a photoresist surface charge state.

20. The method of claim 11, wherein the steps of positioning, adjusting, and determining are repeated over selected areas of the process surface.
